(19) United States
(12) Patent Application Publication
(10) Pub. No.: US 2023/0183464 A1
(43) Pub. Date: Jun. 15, 2023

(54) THERMOPLASTIC POLYMER COMPOSITION WITH REDUCED MIGRATION OF STABILISERS

(71) Applicant: INEOS STYROLUTION GROUP GMBH, Frankfurt am Main (DE)

(72) Inventor: Norbert NIESSNER, Friedelsheim (DE)

(21) Appl. No.: 17/997,600

(22) PCT Filed: May 3, 2021
(86) PCT No.: PCT/EP2021/061519

§ 371 Date: Oct. 31, 2022

(30) Foreign Application Priority Data
May 4, 2020 (EP) 20172784.9

(51) Int. Cl. C08L 25/06; C08L 25/10; C08K 5/00

(52) U.S. Cl. CPC C08L 25/06; C08L 25/10; C08K 5/005; C08L 2205/02

(57) ABSTRACT

A thermoplastic polymer composition (A) leads to reduced migration of stabilisers or other ingredients (I), if it contains e.g. 50 to 90 wt. %, relative to the polymer composition (A), of a thermoplastic polymer (P), which has migration barrier properties, as well as at least one stabiliser component (S) and/or a further ingredient (I), wherein the following is true for the polymer composition (A): a) the glass transition temperature T_{g} of the thermoplastic polymer (P) is greater than the use temperature; and b) the polymer-specific constant for polymers (Ap) of the thermoplastic polymer (P) is less than I; and c) the derived diffusion coefficient (Dp) of the thermoplastic polymer (P) for mineral oil is less than 10⁻¹² cm^{2/s} at 20° C.; and d) the morphology of the thermoplastic polymer (P) is either single-phase homogeneous, or two-phase heterogeneous.

The present invention relates to thermoplastic polymer compositions with reduced migration of stabilizers and/or further ingredients. These thermoplastic polymer compositions comprise at least one thermoplastic polymer, which has migration barrier properties for stabilizers and/or for further ingredients, and also, in one embodiment, at least one stabilizer component.

The functional barrier properties of various polymers and multilayer composite structures have so far not been the subject of adequate practical investigation (see, for example, InnoLETTER of Jul. 6, 2010, Rainer Brandsch, “Recycled cardboard and paper for food packaging? Migration of mineral oil from cardboard packaging into foods can be minimized by introduction of a functional barrier” InnoLETTER, pp. 1-8, see www.innoform.de).

The effect of polymers, polymer blends and composite structures as a functional barrier (FB) has been investigated in use primarily in connection with the transmissibility of gases, such as oxygen, carbon dioxide, nitrogen and/or water vapor. In this context, functional barrier properties of polymers and multilayer composite structures with respect to compounds, such as organic molecules, are described in the scientific literature in the form of specific physical constants and thermodynamic compound constants. This enables a selection of materials for the purpose of protecting contents (such as foods), for example, in packaging from contamination by compounds of potential toxicological or olfactory relevance.

In the case of prolonged usage of packaging systems, for example, it is possible, on the basis of the functional barrier properties of the materials, to develop a risk assessment and, derived from it, a plan of measures, and this, in the case of foods or pharmaceuticals, for example, may ensure the safe use of packaging materials, including printing inks, varnishes, coatings, adhesives, etc. As a result, in general, there is no need for time-consuming and costly laboratory tests, or such tests are reduced to a minimum.

An object of the invention, accordingly, is the provision of a thermoplastic polymer composition which can be produced inexpensively and features reduced migration of ingredients and/or stabilizer(s) it contains. The thermoplastic polymer composition may be used for producing composite systems having two or more layers.

Described below is a thermoplastic polymer composition (A) with reduced migration, which comprises at least 20 wt %, more particularly at least 50 wt %, often at least 80 wt %, based on the polymer composition (A), of at least one thermoplastic polymer (P) which exhibits migration barrier properties, especially for stabilizer(s).

This polymer composition (A) contains often at least 0.1 wt %, more particularly 0.1-2.0 wt %, based on the polymer composition (A), of at least one stabilizer component (S). It frequently also comprises further ingredients and/or additives.

The invention relates more particularly to a thermoplastic polymer composition (A) with reduced migration of stabilizers (S) and/or further ingredients (I), comprising at least 20 wt %, more particularly at least 50 wt %, often at least 80 wt %, based on the polymer composition (A), of at least one thermoplastic polymer (P) which has migration barrier properties for stabilizers, and optionally at least 0.1 wt %, often 0.1-2.0 wt %, based on the polymer composition (A), of at least one stabilizer component (S) and/or at least 0.1 wt %, based on the polymer composition (A), of at least one further ingredient (I), where for the thermoplastic polymer composition (A):
a) the glass transition temperature T_{g} of the thermoplastic polymer (P) is above the service temperature, and
b) the polymer-specific constant for polymers (Ap) of the thermoplastic polymer (P) is less than 1, and
c) the diffusion coefficient (Dp), derived therefrom, of the thermoplastic polymer (P) for mineral oil is less than 10⁻¹² cm²/s, at 20° C., and
d) the morphology of the thermoplastic polymer (P) is either single-phase homogeneous, or two-phase heterogeneous,
   where, in the case of two-phase heterogeneous morphology of the thermoplastic polymer (P), the polymer component (Pp) having the higher Ap and the higher diffusion coefficient (D_{P}) present as a discontinuous phase in particle form with a weight-average particle size (D) of 20 nm to 10 μm, is embedded in a polymer component (Pₘ) of lower A_{P} and lower diffusion coefficient (D_{P}), and
   where the morphology of the thermoplastic polymer (P) does not have a cocontinuous structure.

By migration barrier properties are meant that the migration of the stabilizer and/or of the further ingredient in the polymer composition is prevented or at least retarded. By a heterogeneous morphology is meant that there is no homogeneous structure in the polymer or the polymer mixture. This can be assessed by means of microscope investigation, for example.

One embodiment of the invention relates to a thermoplastic polymer composition (A) with reduced migration which contains 50 to 99.9 wt %, based on the polymer composition (A), of at least one thermoplastic polymer (P), and also at least 0.1 wt %, often 0.1 to 2.0 wt %, based on the polymer composition (A), of at least one stabilizer component (S) and/or at least 0.1 wt %, often 0.1 to 2.0 wt %, based on the polymer composition (A), of at least one further ingredient (I).

One embodiment of the invention relates to a thermoplastic polymer composition (A) with reduced migration, which comprises as thermoplastic polymer (P) a styrene-containing polymer having a glass transition temperature T_{g} of at least 60° C., more particularly at least 70° C.

The thermoplastic polymer composition (A) with reduced migration, more particularly for stabilizers, comprises preferably as thermoplastic polymer (P) a styrene-containing polymer component, more particularly from the group consisting of polystyrene (PS), more particularly HIPS and GPPS, and also SBS copolymer/PS blends.

Preference is given to using SBC copolymer/PS blends in the composition.

A further embodiment of the invention relates to a thermoplastic polymer composition (A) with reduced migration, which comprises at least one stabilizer component (S) from the group consisting of antioxidants and light stabilizers, and/or at least one further ingredient (I) from the group consisting of residue monomers and oligomers. The various stabilizer components (S) and further ingredients (I) are described comprehensively hereinafter.

A further embodiment of the invention relates to a thermoplastic polymer composition (A) with reduced migration, which contains 0.1 to 2.0 wt %, often 0.1-1.0 wt %, based on the polymer composition (A), of at least one stabilizer component (S), more particularly at least one antioxidant. These are described below.

A further subject of the invention is a composite structure, suitable more particularly for packaging use, comprising at least two different layers (S).

Here at least one layer (S1) consists of a thermoplastic polymer composition (A) with reduced migration as described above, or consists largely thereof.

This composite structure for packaging use often comprises at least two different layers, where at least one layer (S1) consists largely of a thermoplastic polymer composition (A) of, in particular, polystyrene (PS), SBS copolymer/PS blends and/or SBC copolymer/PS blends, and at least one further layer (S2) consists largely of a non-styrene-containing thermoplastic polymer composition (A2). This further thermoplastic polymer composition (A2) may consist for example of a polyester, polyurethane and/or polyamide.

A further subject of the invention is a process for producing a thermoplastic polymer composition (A) with reduced migration of stabilizers (S) and/or further ingredients (I), as described above, wherein at least one thermoplastic polymer (P) which has migration barrier properties is mixed with at least one stabilizer component (S) and also optionally further polymer additives. The further polymer additives are described below.

The invention further relates to the use of a thermoplastic polymer composition (A) with reduced migration of stabilizers (S) and/or further ingredients (I), as described above, for producing films, fibers or moldings.

Another subject is the use of a composite structure, as described, comprising at least two different layers, wherein at least one layer (S1) consists of a thermoplastic polymer composition (A) with reduced migration, for providing packaging with enhanced resistance to delamination. Delamination here refers to the detachment of layers in the composite structure. It is a technical challenge in particular where there are two or more layers, e.g., layer (S1) as described above, (S2) and/or (S3).

The barrier properties of polymers with respect to organic molecules are described in particular by the value referred to as the polymer-specific constant (A_{P}).

This constant is described by T. Begley, L. Castle et al. in “Evaluation of migration models that might be used in support of regulations for food contact plastics” (Food Additives and Contaminants, January 2005; 22(1): 73-90). The equation for the polymer-specific constant Ap is as follows (equation 1)

A_{P}=A_{P}′−τ/T (equation 1)

The value described for the polymer-specific constant (A_{P}) in the publication from 2005 is composed of a temperature-independent component A_{P}′ and of the temperature-dependent contribution to the activation energy (τ, Tau). T in equation 1 denotes the temperature.

Table 1 describes the polymer-specific constant A_{P} of some customary polymers which may be used for purposes including the production of packaging.

### Polymer-Specific Constants (A_{P}) for Polymers

| Polymer | Ā_{P′} | S | A_{P′(max)} | A_{P′(min)} | N | t | A_{P′}* | τ |
|---|---|---|---|---|---|---|---|---|
| LDPE | 10.0 | 1.0 | 11 | 7.0 | 27 | 1.7 | 11.7 | 0 |
| HDPE | 10.0 | 1.9 | 12.6 | 5.0 | 49 | 1.68 | 13.2 | 1577 |
| PP | 9.4 | 1.8 | 12.9 | 6.2 | 53 | 1.68 | 12.4 | 1577 |
| PET | 2.2 | 2.5 | 7.2 | −4.3 | 58 | 1.67 | 6.35 | 1577 |
| PEN | −0.34 | 2.4 | 3.8 | −5.5 | 38 | 1.7 | 3.7 | 1577 |
| PS | −2.8 | 1.25 | 0.0 | −6.5 | 32 | 1.7 | −0.7 | 0 |
| HIPS | −2.7 | 1.67 | 0 | −6.2 | 33 | 1.7 | 0.1 | 0 |
| PA (6,6) | −1.54 | 2.0 | 2.3 | −7.7 | 31 | 1.7 | 1.9 | 0 |

The polymer-specific constant A_{P} is a measure of the mobility of the polymers at a molecular level and therefore enables an estimation of their barrier properties (or the diffusion properties).

Flexible polymers, such as polyethylene (LDPE) or plasticizer-containing polyvinyl chloride (plasticized PVC), generally have a high mobility, meaning that they possess correspondingly higher A_{P} values and diffusion coefficients Dp, leading to low barrier properties.

More rigid polymers, such as polyethylene terephthalate (PET) or polyamide (PA), are generally distinguished by a lower mobility, meaning that they have correspondingly lower A_{P} values and diffusion coefficients Dp and therefore lead to better barrier properties.

The diffusion equation describes the diffusion coefficient (Dp) as follows:

D_{P}˜exp(A_{P}−0.1351Mr^{2/3}+0.003Mr−10454/T) (equation 2)

The polymer-specific constant Ap describes the polymer matrix (e.g., free volume, chain mobility) and is temperature-dependent, as shown above in equation 1. Mr is the molecular weight of the migrant (e.g., stabilizer, additive); T is the temperature.

A further contribution to the barrier effect of polymers is made by the solubility of the migrating additive in the polymer or the polymer composition. The solubility is compound-specific and except for a few media, such as water, is described only to a limited extent in the literature. If the solubility of the compound in the polymer is low, the barrier effect of the polymer with respect to that compound is generally high.

A classic example of this is the good barrier property of polyethylene (PE) with respect to water or water vapor, because water is not soluble in PE. As a result of its molecular size as well, the migrating compound has an influence on the barrier effect of the polymer. Small molecules such as solvents, acetone for example, migrate more rapidly through a polymer than do large molecules, such as customary polymer additives, for example. One practical example from use are low-migration printing inks, which deliberately employ large molecules such as polymeric photoinitiators, for example, in order to ensure low migration values.

The thickness of the polymer product itself also influences its barrier effect. Thick polymer layers, of the kind used in beakers or trays, for example, have a higher barrier effect than, for example, thin films of the same polymer. The effect of the temperature on the migration rate is high, meaning that the same migration of compound is achieved within a few hours under sterilization conditions (high temperature) and within a few years at room temperature (20° C.).

Whether the barrier effect (functional barrier) of a polymer in respect of a particular application (contents, storage time, storage temperature) is sufficient can be assessed with a holistic consideration of all the influencing variables (polymer type and polymer thickness, migrating compound and its molecular weight and solubility in the polymer, storage time and storage temperature, nature of the contents).

Mineral oil may be used to investigate the barrier properties. Considering, for example, the barrier effect of polymers for mineral oil (average molecular weight 300-520 g/mol) at room temperature (around 20° C.), a rational selection of materials for packaging solutions can be made simply from the polymer-specific constant (A_{P}). A high A_{P} denotes a low barrier effect and a low A_{P} denotes a high barrier effect. LDPE, correspondingly, has virtually no barrier effect for mineral oil. Very good barrier effects are exhibited by PET or polystyrene even at low thickness (around 10 μm).

Table 2 shows polymer-specific constants (A_{P}) for polymers and, derived from them, diffusion coefficients (D_{P}) for mineral oil at RT (20° C.):

| | D_{P} [cm²/s] | A_{P} |
|---|---|---|
| Gases | ~10⁻¹ | |
| Liquids | ~10⁻⁵ | 20 |
| Viscous fluids | ~10⁻⁶ | 18 |
| Plasticized PVC | ~10⁻⁷ | 16 |
| Polymers T > T_{g} | | |
| LDPE | ~10⁻⁹ | 11 |
| HDPE | ~10⁻¹⁰ | 9 |
| PP | ~10⁻¹¹ | 7 |
| Polymers T < T_{g} | | |
| PA | ~10⁻¹³ | 2 |
| PS | ~10⁻¹⁴ | around 0 |
| PET | ~10⁻¹⁵ | −2 |
| rigid PVC | ~10⁻¹⁶ | −4 |

Tg is the glass transition temperature; T<Tg means that the usage temperature is below the glass transition temperature of the polymer.

From the A_{P}, the molecular weight of the migrant, and the temperature it is possible to estimate the diffusion coefficient of mineral oil in the respective polymer and to use for the specific application-related simulation of migration, what is referred to as migration modeling on the basis of the diffusion law.

Real-world packaging systems frequently consist, however, of multiple materials and/or articles such as, for example, bottle and cap or thermoformed tray and lidding film. Further items are labels, wrappers, sleeves, folding boxes, outer packaging, transient packaging, etc., which wholly or partly surround the contents (solid, liquid, pasty). Certain materials or articles in the packaging system are in direct contact with foods or pharmaceuticals, for example, while others are not. The transfer of mineral oil from recycled cardboard or paper takes place mostly via the gas phase. Transfer via the gas phase is possible because mineral oil has sufficient volatility to desorb from a cardboard fiber, for example, and adsorb on the inner packaging and/or directly on the food.

The volatility of a compound may be expressed by its vapor pressure at a given temperature. It should be borne in mind here that the vapor pressure of the compound may differ significantly from the vapor pressure of the adsorbed or dissolved compound. Mineral oils of low molecular mass have greater volatility than those of high molecular mass. The transfer of mineral oil to food is determined by two key parameters: firstly, the specific surface area of the food, on which the mineral oil is adsorbed relatively nonspecifically, and, secondly, the freely available or accessible fat content of the food, in which moderately polar to nonpolar compounds dissolve well, i.e., are preferentially taken up. A high specific surface area of foods as in the case of flour, rice and cereals, for example, and also a fat content, of several percent in foods, for example, such as in chocolate products or sandwiches, for example, indicate high mineral oil migration levels, where recycled cardboard or paper is used for packaging.

In analogy to the functional barrier within a material or article, the concept of the functional barrier may be extended to a composite structure. For this purpose it is useful to consider the composite structure as concentric layers (S) which surround one another at least partly.

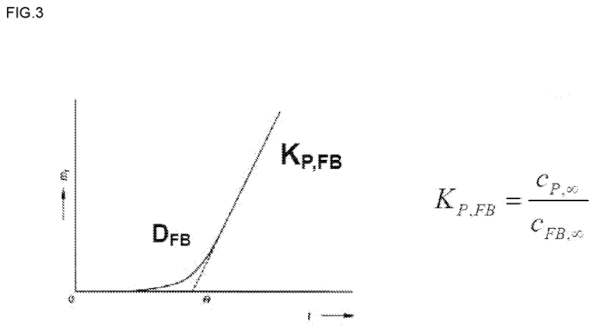

The layer (S) which is to surround the contents (e.g., inner pouch), relative to other, further outward layers (e.g., transient packaging made from (recycled) cardboard), can be varied with regard to the functional barrier properties of the composite structure. The time (t) required by a compound (e.g., stabilizer component) to move from the outside (e.g., outer packaging) through a functional barrier (FB) layer (of polymer composition, for example) is also called the penetration time (theta, Θ) (see FIG. 3).

According to equation 3 below, this penetration time (theta) is directly proportional to the thickness (d) of the layer (S), such as of an inner pouch, for example, dP to the square, and inversely proportional to the diffusion coefficient (DFB) of the material of the functional barrier (FB), that is, for example, of the thermoplastic composition (A).

$$\begin{matrix}θ = \frac{1}{6} * \frac{{d}_{p}^{2}}{{D}_{FB}} & \begin{matrix}θ * penetration time \\ d * thickness \\ D * diffusion coefficient\end{matrix}\end{matrix} \qquad ( equation 3 )$$

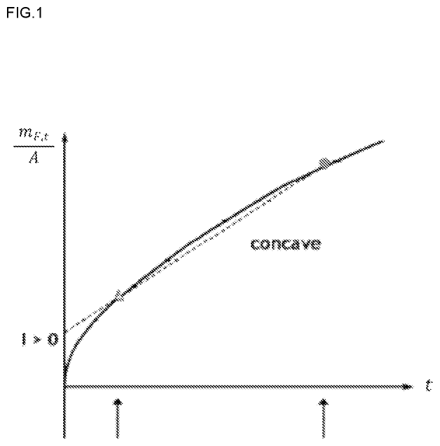

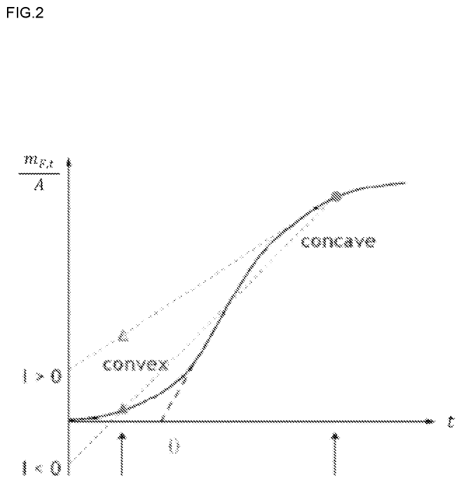

The mode of action of a functional barrier (FB) is also represented in the diagrams of FIGS. 1 and 2. Where the polymer layer (S) has no functional barrier property, the time profile of the migration observed is as shown in FIG. 1. If the migration of the compound (e.g., stabilizer) is determined at two arbitrary points in time, and if the two points are joined by a straight line, this straight line will intersect the y-axis describing the migration: migration (mF, t/A) always at a positive value (I>0).

If, however, the polymer layer (S) has a functional barrier property, then a time profile of the migration observed is as shown in FIG. 2. Where the migration of the compound (e.g., stabilizer) is determined at two arbitrary points in time and the two points are joined by a straight line, the straight line will intersect the y-axis (migration, mF, t/A) at a negative value (I<0) if one time point is located within the penetration time (theta).

A functional barrier in the form of a polymer composition (A) is effective with respect to a stabilizer component (or further ingredient) when the penetration time (theta) is as long as possible. In that case, within the penetration time, there is no transfer or migration of the stabilizer component from outside the functional barrier (FB) into, for example, the contents (to be protected).

This can also be achieved by means of thicker layers of material, but thicker layers appear less conducive from an environmental and economic standpoint.

In the case, for example, of bottles, beakers and trays made of polymers, material thicknesses of several hundred micrometers are often customary, and therefore the penetration times of compounds are particularly important.

Materials having good functional barrier properties, such as the polymer compositions (A) and composite structures with multiple layers (S) comprising at least one such polymer layer (S1), for example, therefore represent an option which is inexpensive to realize technologically. It is more conducive to use compositions through which compounds (such as stabilizers) migrate very slowly.

In the compositions (A), compounds such as stabilizers have a low diffusion coefficient (D_{FB}) and a low migration rate. If the diffusion coefficient of a material at a given temperature is known, the penetration time can be calculated.

FIG. 3 represents the qualitative contribution of the selection of material in relation to the functional barrier effect. A polymer having a low polymer-specific constant (AP) leads to a low diffusion coefficient (DFB) and a correspondingly long penetration time (θ). A low solubility on the part of the organic molecule (e.g., the stabilizer) in the polymer (cFB) leads to low concentrations of the compound in the plastic and therefore to a high partition coefficient (KP,FB). The linear region of the curve has a corresponding flat profile, resulting only in low migration levels (mt) even after a long time.

The diffusion coefficient (D_{FB}) in FIG. 3 describes on the one hand the rate at which a compound migrates into a plastic. On the other hand, the partition coefficient (K_{P,FB}) describes the relative solubility of a compound between adjacent layers/plies of a composite structure (in the case of packaging, for example). On the basis of the two coefficients, it is possible to estimate the functional barrier properties of the polymer compositions (A) in composite structures having multiple layers (S1, S2 etc.) or in packaging material systems, in relation to a further ingredient (e.g., mineral oil).

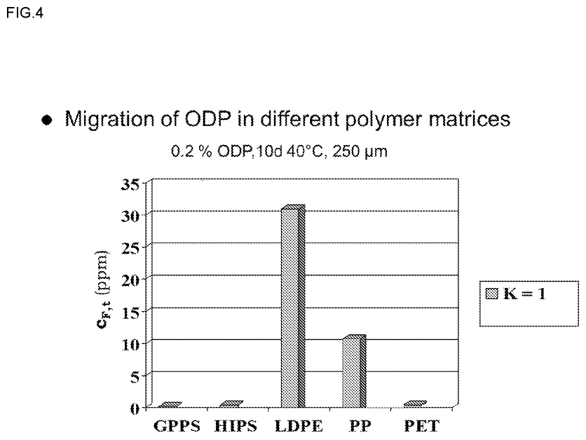

FIG. 4 represents the quantitative migration of mineral oil (ODP) into the polymers general purpose polystyrene (GPPS), HIPS, LD-Polyethylene, polypropylene and PET (in each case 0.2 wt % of ODP, 10 days at 40° C. and a layer thickness of 0.25 mm). It is evident that polyethylene and polypropylene have poor migration barrier properties, while polystyrene and HIPS may be good migration barriers, even at a low layer thickness.

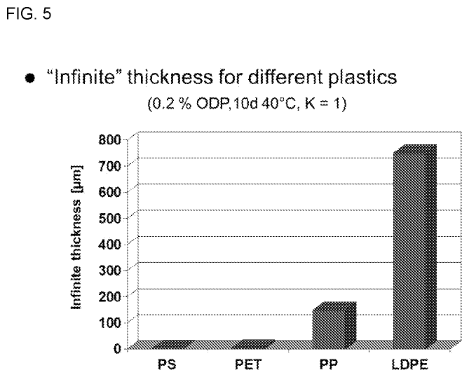

FIG. 5 shows the limiting thickness (“infinite thickness”, C_{F,t}) of films of various polymer materials, namely polystyrene (GPPS, HIPS), PET, polypropylene and LD-polyethylene (in each case 0.2 wt % of ODP, 10 days at 40° C. and a layer thickness at 0.25 mm). It is evident that in the case of polyethylene and propylene, high thicknesses of the polymer layer are required for a migration barrier, whereas with polystyrene good migration barriers can be realized even in the micrometer range of the layers.

The invention relates generally to a thermoplastic polymer composition (A) with reduced migration. It comprises a polymer composition (A) with at least one thermoplastic polymer (P) which has migration barrier properties, especially for stabilizers, and also at least one stabilizer component (S) and/or at least one further ingredient (I), such as monomers (such as styrene) or oligomers (e.g., trimers, etc.), for example. The conditions applying to the thermoplastic polymer composition (A) are those set out above.

In the case of two-phase morphology of the thermoplastic polymer (P), the polymer component (P_{P}) having the higher A_{P} and the higher diffusion coefficient (D_{P}), as a discontinuous phase in particle form with a weight-average particle size (D) of 20 nm to 10 μm, is embedded in a polymer component (P_{M}) with lower Ap and lower diffusion coefficient (D_{P}).

The morphology of the thermoplastic polymer (P) is not to have a cocontinuous structure: it is either single-phase homogeneous or else two-phase heterogeneous.

The morphology of the thermoplastic polymer (P), preferably polystyrene or polystyrene/SBC blend, in particular does not have a cocontinuous structure. Cocontinuous structures are, for example, “bis-continuous double diamond” structures, cylindrical structures (e.g., cylinders of polybutadiene in a matrix of polystyrene), lamellar structures (e.g., lamellae of polybutadiene in a matrix of polystyrene), and interpenetrating networks (IPNs).

The glass transition temperature T_{g} of the thermoplastic polymer (P) is preferably above 50° C., often above 60° C., more particularly above 70° C.

The service temperature of the polymer is frequently in the region of room temperature (20° C.) or else in the cooling range (−20° C.) up to normal transport temperature range (up to 40° C., at most 50° C.).

The polymer-specific constant for polymers (A_{P}) of the thermoplastic polymer (P) is preferably less than 1.0, for example −2.0 to 0.95, more particularly −1.8 to 0.93.

The diffusion coefficient (Dp) of the thermoplastic polymer (P) for mineral oil is preferably less than or equal to 10⁻¹² cm²/s at 20° C.

Suitable thermoplastic polymers (P) are not only single-phase standard polystyrene (GPPS, general purpose polystyrene, manufacturer e.g., INEOS Styrolution) but also impact-resistant polystyrenes, such as HIPS (High-Impact Polystyrene, manufacturer e.g., INEOS Styrolution). Frequently blends of PS and SBS copolymers or blends of PS and SBC copolymers are also used, meeting the above criteria.

The at least one stabilizer component (S) is selected, for example, from the group containing antioxidants and light stabilizers.

In one embodiment, the thermoplastic polymer composition (A) with reduced migration comprises from 50 to 99.9 wt %, based on the polymer composition (A), of at least one thermoplastic polymer (P), and also 0.1 to 2.0 wt %, based on the polymer composition (A), of at least one stabilizer component (S) and/or at least one further ingredient (I).

The polymer composition (A) often contains 70 to 99 wt %, based on the polymer composition (A), of at least one thermoplastic polymer (P), or often comprises a mixture of two or more polymers, such as polystyrene and styrene copolymer (such as SB copolymer).

In a further embodiment the thermoplastic polymer composition (A) with reduced migration of stabilizer (S) and/or further ingredient (I) comprises as thermoplastic polymer (P) a styrene-containing polymer having a glass transition temperature T_{g} of at least 60° C., more particularly at least 70° C., and also (optionally) as stabilizer component (S) up to 5 wt %, more particularly 0.1 to 2.0 wt %, often 0.1 to 1.0 wt %, based on the polymer composition (A), of at least one antioxidant as additive.

The thermoplastic polymer (P) is often a styrene-containing polymer component, preferably from the group of the polystyrenes (PS), more particularly HIPS and GPPS, or a blend of styrene-containing polymer component and S/B block copolymer, e.g., an SBS copolymer/PS blend or SBC copolymer/PS, e.g., PS-SBC blend.

The stabilizer component (S) preferably comprises at least one stabilizer from the group of the antioxidants.

Such antioxidants have, for example, either one or two or more sterically protected phenolic OH groups, and/or phosphite units and/or sulfur compounds. Examples of suitable antioxidants are:
2,6-di-tert-butyl-p-cresol
2,2′-methylenebis(4-methyl-6-tert-butylphenol)
2,2′-methylenebis-(4-methyl-6-cyclohexylphenol)
2,2′-methylenebis(6-tert-butyl-4-ethylphenol)
octadecyl 3-(3,5-di-tert-butyl-4-hydroxphenyl)propionate
pentaerythritol tetrakis(3-(3,5-di-tert-butyl-4-hydroxyphenyl)propionate)
octyl 3,5-di-tert-butyl-4-hydroxyhydrocinnamate
triethylene glycol bis(3-tert-butyl-4-hydroxy-5-methylphenyl)propionate
thiodiethylene bis[3-(3,5-di-tert-butyl-4-hydroxyphenyl)propionate]
N,N′-hexane-1,6-diylbis[3-(3,5-di-tert-butyl-4-hydroxyphenylpropionamide]
6,6′-di-tert-butyl-4,4′-butylidenedi-m-cresol
1,3,5-trimethyl-2,4,6-tris(3,5-di-tert-butyl-4-hydroxybenzyl)benzene
2,4-bis(octylthio)-6-(4-hydroxy-3,5-di-tert-butylanilino)-1,3,5-triazine
2-methyl-4,6-bis(octylsulfanylmethyl)phenol
phenol, 4-methyl-, reaction products dicyclopentadiene and isobutylene
1,2-di[-(3,5-di-tert-butyl-4-hydroxphenyl)propionyl]hydrazine
3,3′-bis(3,5-di-tert-butyl-4-hydroxyphenyl)-n,n′-bipropionamide
2-(1,1-dimethylethyl)-6-[[3-(1,1-dimethylethyl)-2-hydroxy-5-methylphenyl]methyl]-4-methylphenyl acrylate
2-(1-(2-hydroxy-3,5-di-tert-pentylphenyl)ethyl)-4,6-di-tert-pentylphenyl acrylate
2-tert-butyl-6-methyl-4-[3-(2,4,8,10-tetra-tert-butylbenzo[d][1,3,2]benzodioxaphosphepin-6-yl)oxpropyl]phenol
2-(1,1-dimethylethyl)-6-[[3-(1,1-dimethylethyl)-2-hydroxy-5-methylphenyl]methyl]-4-methylphenyl acrylate
1,3,5-tris(3,5-di-tert-butyl-4-hydroxybenzyl)-1,3,5-triazine-2,4,6(1H,3H,5H)-trione
4,4′,4″-(1-methylpropanyl-3-ylidene)tris(6-tert-butyl-m-cresol)
3,9-Bis{2-[3-(3-tert-butyl-4-hydroxy-5-methylphenyl)propionyloxy]-1,1-dimethylethyl}-2,4,8,10-tetraoxaspiro[5.5]undecane
4,4′-thiobis(2-tert-butyl-5-methylphenol)
ethylene bis[3,3-bis[3-(1,1-dimethylethyl)-4-hydroxyphenyl]butanoate]
2,4-dimethyl-6-(1-methyl pentadecyl) phenol
hexamethylene bis[3-(3,5-di-tert-butyl-4-hydroxyphenyl)propionate]
TNPP (tris-nonylphenyl) phosphite
diethyl 3,5-di-tert-butyl-4-hydroxybenzylphosphonate
calcium diethyl-bis[[[3,5-bis(1,1-dimethylethyl)-4-hydroxyphenyl]-methyl]phosphonate]
tocopherol
tris(4-tert-butyl-3-hydroxy-2,6-dimethylbenzyl) isocyanurate
3-tert-butyl-2-hydroxy-5-methylphenylsulfide
4-[[4,6-bis(n-octylthio)-1,3,5-triazin-2-yl]amino]-2,6-di-tert-butylphenol
Benzenepropanoic acid 3,5-bis(1,1-dimethylethyl)-4-hydroxy-,C13-15-alkyl ester
tris(2,4-di-tert-butylphenyl) phosphite
other organophosphorus stabilizers.

Examples of stabilizers employed were preferably:

2-tert-butyl-6-[(3-tert-butyl-2-hydroxy-5-methylphenyl)methyl]-4-methylphenyl prop-2-enoate);

TNPP (trisnonylphenyl) phosphite.

Examples employed preferably of further ingredients were:

white oil, lubricants, styrene oligomers.

Combinations of different stabilizers are often also used, in which case preferably in total up to 2.0 wt % of stabilizers are used, based on the polymer composition (A).

The invention also relates, furthermore, to a composite structure, more particularly suitable for packaging use, comprising at least two different layers, where at least one layer (S1) consists of a thermoplastic polymer composition (A) with reduced migration of stabilizers as described above.

This layer (S1) preferably faces the inside in the case of packaging, e.g., for contact with foods, for example.

In one embodiment, the composite structure comprises at least two different layers, where at least one layer (S1) consists of a thermoplastic polymer composition (A) with reduced migration, and a second layer (S2), and optionally further layers S3, S4, S5, with the composite structure being suitable for providing packaging with enhanced resistance to delamination.

The invention further relates to a process for producing a thermoplastic polymer composition (A) with reduced migration, wherein at least one thermoplastic polymer (P) which has migration barrier properties for stabilizers is mixed with a stabilizer component (S) and also optionally further polymer additives, different from the component (S). Various processes for mixing or compounding thermoplastic compositions with additives are known to the skilled person. The stabilizer component(s) may also be introduced in the form of masterbatches into the composition.

In analogy to the functional barrier within a material or article, the concept of the invention of the functional barrier may be extended to a whole packaging system. For this purpose it is conducive to interpret a packaging system as concentric plies at least partly surrounding one another. Materials or articles in this case are in some cases not in direct contact with one another, there being instead, for example, air or another gas possibly located between them.

EU Regulation (EC) No. 1935/2004 of October 2004 is valid according to Article 1 for materials and articles, including active and intelligent food contact materials and articles, which in their finished state are intended to be brought into contact with food, or are already in contact with food and are intended for that purpose, or can reasonably be expected to be brought into contact with food or to transfer their constituents to food under normal or foreseeable use.

In accordance with the invention, investigations were also made as to which polymeric materials or products which may enclose (e.g., inner pouches) possibly sensitive contents (e.g., foodstuffs) have good functional barrier properties with respect to other materials located further to the outside (e.g., transient packaging made from recycled cardboard or polymer).

Investigations were carried out analogously into whether, for example, a film or a molding (tray) of an aforementioned polymer composition possesses functional barrier properties with respect to compounds from an applied label, or whether a substrate composed of a polymer composition represents an effective functional barrier to compounds from the applied printing ink (e.g., photoinitiators, stabilizers). The time taken by a compound in order to move from the outside (e.g., outer packaging or printing ink) through a functional barrier (e.g., primary packaging or substrate) is also called the penetration time θ (theta). This penetration time according to equation 4 is directly proportional to the thickness of the inner pouch, dP to the square, and inversely proportional to the diffusion coefficient DFB of the compound in the functional barrier (FB):

$$θ = \frac{1}{6} * \frac{{d}_{p}^{2}}{{D}_{FB}} \qquad ( equation 4 )$$

The mode of action of a functional barrier is also represented in the diagrams in FIG. 1 and FIG. 2, where the migration (mF,t/A) is plotted against the time (t).

Where no functional barrier is present or where the migrating compound is located in the food contact layer, a time profile of migration is observed that corresponds to the graph of FIG. 1. If the migration of the compound is determined at two arbitrary points in time, and if the two points are joined by a straight line, the straight line will always intersect the y-axis (migration, mF,t/A) at a positive value (I>0).

If a functional barrier is present, the time profile of the migration observed corresponds to the graph of FIG. 2. If the migration of the compound is determined at two arbitrary points in time, and if the two points are joined by a straight line, the straight line will intersect the y-axis (migration, mF,t/A) at a negative value (I<0) if one point in time is located within the penetration time θ (lag time). A functional barrier (FB) composed of a polymer is effective relative to a compound if the penetration time θ is as long as possible. Within the penetration time there is no transfer/migration of the compound from outside the FB into the contents. This may be achieved by a thick layer, but a thick layer is not very conducive from the standpoint of preserving resources and economic efficiency.

In the case, for example, of bottles, beakers and trays made from polymer, however, thicknesses of material of several hundred micrometers are not unusual. Correspondingly, the penetration times for compounds are longer than in the case of films with the same material constitution.

The use of materials such as glass or metal as an absolute barrier to the migration of compounds in the sector of flexible packaging appears to be only a hypothetical option, owing to a number of disadvantages.

Materials with functional barrier properties, such as the above polymers and multilayer composites, for example, represent an option which is realizable inexpensively from a technological standpoint. It is conducive to use materials through which compounds are able to pass/migrate only very slowly. In barrier materials, compounds have low diffusion coefficients DFB, i.e., a low migration rate. Diffusion coefficients can in some cases be found in the literature or may be estimated according to scientifically recognized methods. If the diffusion coefficient of a compound in a material at a given temperature is known, it is possible to calculate the penetration time according to the above equation.

In the context of the studies in the invention, the qualitative contribution of the selection of material in relation to the functional barrier effect was represented.

Polymers having a low polymer-specific constant (AP) lead to low diffusion coefficients (DFB) and to correspondingly large penetration times θ. A low solubility of the migrant (e.g., organic additive) in the polymer (cFB) leads to low concentrations of the additive in the polymer and hence to a high partition coefficient (KP, FB). The linear region of the curve has a correspondingly flat profile, so resulting in low migration levels (mt) even after a long time.

FIG. 3 describes the “diffusion coefficient” constant (DFB). This describes the rate at which a compound migrates into a polymer. Described alternatively is the “partition coefficient” (KP,FB), which describes the relative solubility of a compound (e.g., additive) between adjacent layers/plies of a composite system (e.g., packaging). On the basis of the two coefficients, it is possible to calculate or estimate the functional barrier properties of polymers in multilayer composite structures or packaging-material systems in relation to an additive, such as mineral oils or stabilizers. Hence it is possible to determine the efficacy of a functional barrier with respect to migratable compounds.

FIG. 4 describes the different solubility (cFB) of an additive (0.2% ODP) in various polymers, and the associated different migration (10 days at 40° C.). This is particularly low in the case of the styrene-containing polymers GPPS and HIPS. The K value is the partition coefficient of the migrating additive in a system of polymer and food simulant (solvent). The K value (more precisely K_{P/L}) of 1 means that a migrating additive (e.g., ODP) resides at an equilibrium 1×more in the polymer than in the solvent. In the presence of 50% ethanol the K value for PE and PS tends toward 1.

FIG. 5 describes, for various polymers (polystyrene, PET, polypropylene and LD-polyethylene), the “infinite thickness” (additive 0.2% ODP; 10 days at 40° C.), which is particularly low in the case of the styrene-containing polymers such as PS in particular.

The glass transition temperature of a polymer also proves to be important for the barrier effect against the migration of polymer additives. The polymer EPP, a particularly tough foam made from expanded polypropylene, is generally foamed at the premises of the user. As a result of the low T_{g} of PP (5° C.), the chain mobility of PP at room temperature is so high that PP pellets charged with a foaming agent (e.g., pentane) lose their foaming agent within an extremely short time (in storage or transit). Conversely, EPS (expandable polystyrene) can be charged by the manufacturer as a pellet with the foaming agent pentane, without any significant loss of pentane during storage and transit. This is due to the high T_{g} of polystyrene, which even on mixing with up to 5% pentane drops only to around 80° C. and is high enough to avoid chain mobility at room temperature.

Further suitable additives include the following:

Further light stabilizers used may be all customary light stabilizers, examples being compounds based on benzophenone, benztriazole, cinnamic acid, and sterically hindered amines (HALS).

Lubricants contemplated include, for example, hydrocarbons such as oils, paraffins, PE waxes, PP waxes, fatty alcohols of 6 to 20 carbon atoms, ketones, carboxylic acids such as fatty acids, montanic acid or oxidized PE wax, carboxamides and also carboxylic esters, for example with the alcohols ethanol, fatty alcohols, glycerol, ethanediol and pentaerythritol, and long-chain carboxylic acids as acid component.

Stabilizers used may be customary antioxidants, examples being phenolic antioxidants, such as alkylated monophenols, esters and/or amides of b-(3,5-di-tert-butyl-4-hydroxyphenyl)propionic acid and/or benzotriazoles. (Trisnonylphenyl) phosphite as well may often be used. Antioxidants are also stated illustratively in EP-A 698637 and EP-A 669367 and mentioned in Plastics Additives Handbook, (H. Zweifel, Munich 2009). Phenolic antioxidants used, for example, may be 2,6-di-tert-butyl-4-methylphenol, pentaerythrityl tetrakis[3-(3,5-di-tert-butyl-4-hydroxyphenyl)propionate] and N,N′-di-(3,5-ditert-butyl-4-hydroxyphenylpropionyl)hexamethylenediamine. The stated stabilizers may be used individually or in mixtures.

The polymer compositions (A) of the invention may for example be granulated or pelletized, or processed by commonly known methods, as for example by extrusion, injection molding or calendering, to form films, hoses, fibers, profiles, footwear shells, shaped technical parts, utility articles, moldings of all kinds, coatings and/or blow moldings.

The invention is elucidated in more detail by the examples, figures, and the claims.

### EXAMPLES

To illustrate the technical advantages of the invention, the migration of three different additives was investigated:

(Antioxidant 1): Sumilizer GM (phenolic stabilizer from Sumitomo Chemical, JP) (2-tert-butyl-6-[(3-tert-butyl-2-hydroxy-5-methylphenyl)methyl]-4-methylphenyl prop-2-enoate);

(Antioxidant 2): TNPP (phosphite stabilizer)

(trisnonylphenyl) phosphite;

(Mineral Oil): commercial white oil (plasticizer, e.g., from Eni Oilproducts).

These following polymers were used:

SBS1: Styrolux 3G55 (INEOS Styrolution, Frankfurt), a coupled (star-shaped) SBS polymer with the following empirical composition:

74% styrene/26% butadiene.

Polystyrene 158 (INEOS Styrolution, Frankfurt, standard PS with Vicat B/50 of 101° C. containing no white oil).

2.5 wt % of mineral oil (white oil DAB 10); 0.25 wt % of antioxidant 1 (“Sumilizer GM”); and 0.4 wt % of antioxidant 2 (trisnonylphenyl phosphate (TNPP)) were added as stabilizers/ingredients during the melt processing.

SBS+PS

Additionally mixtures of the polymer component SBS1 with polystyrene 158 (INEOS Styrolution, Frankfurt, Standard-PS with Vicat B/50 of 101° C., containing no white oil) were prepared.

These mixtures were produced by mixing on a twin-screw extruder ZSK30 (Coperion) at a melt temperature of around 240° C.:
SBS1+25% PS means: blend of 75 wt % of Styrolux 3G55 with 25 wt % of polystyrene 158 (stable morphology: 2-phase blend with lamellar/cylindrical structure);
SBS1+50% PS means: blend of 50 wt % of Styrolux 3G55 with 50 wt % of polystyrene 158 (morphology consisting primarily of PS as homogeneous, continuous phase and polybutadiene-co-styrene as discontinuous phase, dispersed in particles, lamellae being visible in part);
SBS1+75% PS means: blends of 25 wt % of Styrolux 3G55 with 75 wt % of polystyrene 158 (stable morphology with PS as homogeneous, continuous phase and polybutadiene-co-styrene as discontinuous phase, distributed in particles).

The respective morphology was determined on the basis of ultramicrotome thin-layer sections contrasted using RuO₄, by means of a conventional scanning electron microscope at a magnification of 100 000 to 1.

Implementation of the migration measurements:

The use of oil as a fat simulant is less suitable owing to technical difficulties with analysis, and also 95% ethanol and also isooctane are less instructive as fat simulants, owing to high levels of interaction with the polymer matrix. Aqueous simulants are difficult because of the very low solubility of the additives.

For this reason, migration cells were used into which polymer films were clamped that consisted of the following polymer compositions:
“SBS1”,
“SBS+25% PS”
“SBS+50% PS” and
“SBS+75% PS”
   each with a thickness of 1 mm (tab 3) and in each case between 2 polyethylene films (LDPE) 0.5 mm thick. The blank migration values with polyethylene (LDPE) were determined. Following extraction with diethyl ether, the amounts of migrated substances (after the times and temperatures indicated in tab. 3a) were determined by means of FID gas chromatography:

TABLE 3
Instrument parameters:

| | |
|---|---|
| Column: | DB1ht, 30 m, ID 0.25 mm, film 0.1 μm |
| Carrier gas/flow: | helium; 1.6 ml/min; 35 cm/sec |
| Injector: | split/splitless; 320° C. |
| Injection: | 1 μm splitless |
| Detector: | FID; 320° C. |
| Temperature program: | 60° C. (2 min) 20° C./min 320° C. |

The results of the kinetic measurements of the migration (at 40-70° C., in μg/dm2) of the ingredients in SBS and SBS+25% PS and of the further blends according to the invention (SBS+50 and +75% PS) are shown in table 3a.

The diffusion coefficients D_{P}, were ascertained from the migration values for the respective polymer matrix and the corresponding migrant, and were used to determine the migration properties with the aid of equation (1).

TABLE 3a

| | Antioxidant 1 | | | Antioxidant 2 | | | Mineral oil | | |
|---|---|---|---|---|---|---|---|---|---|
| | M = 394 | | | M = 689 | | | M = 515 | | |
| Temp. | 40° | 60° | 70° | 40° | 60° | 70° | 40° | 60° | 70° |
| | C. | C. | C. | C. | C. | C. | C. | C. | C. |
| SBS 1 | 0.26 | 0.56 | 0.76 | 0.26 | 1.86 | 2.47 | 25.2 | 74.1 | 64.0 |
| +25% | | | 0.51 | | | 0.29 | | | 47.6 |
| PS | | | | | | | | | |
| +50% | | | 0.15 | | | <0.1 | | | 9.5 |
| PS | | | | | | | | | |
| +75% | | | <0.01 | | | <0.1 | | | <2 |
| PS | | | | | | | | | |

The diffusion coefficients Dp were ascertained from the migration values for the respective polymer matrix and the corresponding migrants, and were used to calculate the Ap values, by means of equation 2; see

TABLE 3b

| | Antioxidant 1 | | | Antioxidant 2 | | | Mineral oil | | |
|---|---|---|---|---|---|---|---|---|---|
| | M = 394 | | | M = 689 | | | M = 515 | | |
| Temp. | 40° | 60° | 70° | 40° | 60° | 70° | 40° | 60° | 70° |
| | C. | | | C. | | C. | C. | C. | C. |
| SBS 1 | 5.0 | 5.0 | 5.1 | 4.5 | 5.5 | 6.0 | 9.0 | 10.3 | 8.9 |
| +25% | | | 3.2 | | | 6.2 | | | 7.0 |
| PS | | | | | | | | | |
| +50% | | | 0.5 | | | n.d. | | | 4.5 |
| PS | | | | | | | | | |
| +75% | | | <−2 | | | <0 | | | <2 |
| PS | | | | | | | | | |

n.d. was not determined

The mineral oil causes the discontinuous polymeric soft phase to swell and in the boundary region leads from a discontinuous (particulate) morphology in accordance with the invention to a partly lamellar morphology, which is accompanied by adverse technical effects. This is apparent, for example, from the compositions with 50 wt % of polystyrene and 50 wt % of Styrolux 3G55 as polymer components.

It was found that on transition from a (cocontinuous) structure of the polymer to the discontinuous particulate structure used in the case of the composition (A) according to the invention, there are distinct reductions both in the migration values and in the A_{P} polymer-specific parameters. This demonstrates that the barrier effect of the polymer composition is increased, so that the polymer composition (A) with reduced migration of stabilizers (or ingredients) in accordance with the invention procures a significant technical advantage.

This is utilized among other things in order to produce packaging with a composite structure having two different layers, layer (S1) of a thermoplastic mixture of 25 wt % of styrene-butadiene-styrene copolymer and 75% of PS, and a further layer (S2) composed of non-styrene-containing thermoplastic, more particularly polyurethane or PET.

1. A thermoplastic polymer composition (A) with reduced migration of stabilizers (S) and/or further ingredients (I), comprising at least 20 wt %, based on the polymer composition (A), of at least one thermoplastic polymer (P) which has migration barrier properties for stabilizers, and optionally at least 0.1 wt %, based on the polymer composition (A), of at least one stabilizer component (S) and/or at least 0.1 wt %, based on the polymer composition (A), of at least one further ingredient (I), where for the thermoplastic polymer composition (A):
a) the glass transition temperature T_{g} of the thermoplastic polymer (P) is above the service temperature, and
b) the polymer-specific constant for polymers (A_{P}) of the thermoplastic polymer (P) is less than 1, and
c) the diffusion coefficient (D_{P}), derived therefrom, of the thermoplastic polymer (P) for mineral oil is less than 10⁻¹² cm²/s, at 20° C., and
d) the morphology of the thermoplastic polymer (P) is either single-phase homogeneous, or two-phase heterogeneous,
where, in the case of two-phase heterogeneous morphology of the thermoplastic polymer (P), the polymer component (Pp) having the higher Ap and the higher diffusion coefficient (D_{P}) present as a discontinuous phase in particle form with a weight-average particle size (D) of 20 nm to 10 μm, is embedded in a polymer component (Pₘ) of lower A_{P} and lower diffusion coefficient (D_{P}),
where the morphology of the thermoplastic polymer (P) does not have a cocontinuous structure.

2. The thermoplastic polymer composition (A) with reduced migration as claimed in claim 1, characterized in that it contains 50 to 99.9 wt %, based on the polymer composition (A), of at least one thermoplastic polymer (P), and also at least 0.1 wt %, often 0.1 to 2.0 wt %, based on the polymer composition (A), of at least one stabilizer component (S) and/or at least 0.1 wt %, often 0.1 to 2.0 wt %, based on the polymer composition (A), of at least one further ingredient (I).

3. The thermoplastic polymer composition (A) with reduced migration as claimed in claim 1 or 2, characterized in that it comprises as thermoplastic polymer (P) a styrene-containing polymer having a glass transition temperature T_{g} of at least 60° C., more particularly at least 70° C.

4. The thermoplastic polymer composition (A) with reduced migration as claimed in at least one of claims 1 to 3, characterized in that it comprises as thermoplastic polymer (P) a styrene-containing polymer component from the group consisting of polystyrene (PS), more particularly HIPS and GPPS, and also SBS copolymer/PS blends and SBC copolymer/PS blends.

5. The thermoplastic polymer composition (A) with reduced migration as claimed in at least one of claims 1 to 4, characterized in that it comprises as thermoplastic polymer (P) a polystyrene (PS) and also an SBS copolymer.

6. The thermoplastic polymer composition (A) with reduced migration as claimed in at least one of claims 1 to 5, characterized in that the thermoplastic polymer (P) comprises at least 50 wt % of polystyrene (PS) and also at least 10 wt % of SBS copolymer.

7. The thermoplastic polymer composition (A) with reduced migration as claimed in at least one of claims 1 to 6, characterized in that it comprises at least one stabilizer component (S) from the group consisting of antioxidants and light stabilizers, and/or comprises at least one further ingredient (I) from the group consisting of residue monomers and oligomers.

8. The thermoplastic polymer composition (A) with reduced migration as claimed in at least one of claims 1 to 7, characterized in that it contains 0.1 to 2.0 wt %, based on the polymer composition (A), of at least one stabilizer component (S), more particularly at least one antioxidant.

9. The thermoplastic polymer composition (A) with reduced migration as claimed in at least one of claims 1 to 8, characterized in that it contains 0.1 to 2.0 wt %, based on the polymer composition (A), of two different stabilizer components (S), and also optionally additionally at least one further ingredient.

10. A composite structure for packaging use, comprising at least two different layers, where at least one layer (S1) consists of a thermoplastic polymer composition (A) with reduced migration as claimed in at least one of claims 1 to 9.

11. The composite structure for packaging use as claimed in claim 10, comprising at least two different layers, where at least one layer (S1) consists largely of a thermoplastic polymer composition (A) of polystyrene (PS), SBS copolymer/PS blends and/or SBC copolymer/PS blends, and at least one further layer (S2) consists largely of a non-styrene-containing thermoplastic polymer composition (A2).

12. A process for producing a thermoplastic polymer composition (A) with reduced migration of stabilizers (S) and/or further ingredients (I), as claimed in any of claims 1 to 9, wherein at least one thermoplastic polymer (P) which has migration barrier properties is mixed with at least one stabilizer component (S) and also optionally further polymer additives.

13. The use of a thermoplastic polymer composition (A) with reduced migration of stabilizers (S) and/or further ingredients (I) as claimed in any of claims 1 to 9 for producing films, fibers or moldings.

14. The use of a composite structure as claimed in at least one of claims 10 and 11, comprising at least two different layers, wherein at least one layer (S1) consists of a thermoplastic polymer composition (A) with reduced migration, for providing packaging with enhanced resistance to delamination.

15. A process for producing a composite structure, comprising at least two different layers, where at least one layer (S1) consists of a thermoplastic polymer composition (A) with reduced migration as claimed in at least one of claims 1 to 9, by providing the layer (S1) and at least one further layer (S2) and also joining the at least two layers.
